(19) United States
(12) Patent Application Publication
(10) Pub. No.: US 2011/0298779 A1
(43) Pub. Date: Dec. 8, 2011

(54) Electrophoretic Device and Driving Method Thereof

(76) Inventors: He-Chen Chen, Hsin-Chu (TW); Wei-Min Sun, Hsin-Chu (TW); Yi-Chien Wen, Hsin-Chu (TW)

(21) Appl. No.: 13/015,582

(22) Filed: Jan. 28, 2011

(30) Foreign Application Priority Data
Jun. 8, 2010 (TW) 099118565

(51) Int. Cl. G09G 5/00; G09G 3/34

(52) U.S. Cl. 345/212; 345/107

(57) ABSTRACT

A driving method for driving an electrophoretic display device is provided. The electrophoretic display device comprises a plurality of scan lines. When scanning a frame of a first set of frames, the plurality of scan lines are sequentially enabled from top to bottom. When scanning a frame of a second set of frames, the plurality of scan lines are sequentially enable from bottom to top.

### BACKGROUND OF THE INVENTION

1. Field of the Invention

The invention relates to a method for driving an electrophoretic display device, and an electrophoretic display device implementing the driving method is also provided herein.

2. Description of the Prior Art

FIG. 1 is a schematic diagram of a conventional electrophoretic display device 100. With reference to FIG. 1, the electrophoretic display device 100 comprises a plurality of pixels 102, a plurality of scan lines 104, a plurality of common lines 106 and a gate driver 108. The gate driver 108 is coupled to the plurality of pixels 102 via the plurality of scan lines 104, and the pixels 102 receive a common voltage signal Vcom through the common lines 106. During a frame period, the gate driver 108 provides scan signals to each of the scan lines 104 sequentially, so as to drive the corresponding pixels 102. Meanwhile, the voltage level of the common voltage signal Vcom is varied according to design requirements.

FIG. 2 is a timing diagram illustrating the conventional driving method of the electrophoretic display device shown in FIG. 1. The driving method is used to drive the scan lines according to a driving sequence. With reference to FIG. 2, in this conventional driving method, the gate lines G1, G2, G3 . . . Gm are sequentially driven in a first frame period 202, and the common voltage signal Vcom is converted, for instance, from a high voltage level to a low voltage level, just before starting a second frame period 204. The gate lines G1, G2, G3 . . . Gm are then sequentially driven in the second frame period 204, and the common voltage signal Vcom is converted again, for instance, from the low voltage level to the high voltage level, just before starting the next frame period.

FIG. 3 is a schematic diagram illustrating a prior micro-cup structure 300 of the electrophoretic display device 100 shown in FIG. 1. As shown in FIG. 3, the micro-cup structure 300 comprises an array of a plurality of micro-cups 304a, 304b, and 304c. The micro-cups 304a, 304b and 304c, packaged in a sealing layer 306, are filled with charged particles 302 and fluid 308. The motion of charged particles 302 can be controlled by applying an external electric field for presenting the effects of different gray levels. For instance, in the micro-cup 304a, when the charged particles 302 are driven by an external electric field at a low voltage level, the charged particles 302 move downward such that a corresponding pixel displays a black gray level; on the contrary, in the micro-cup 304b, the charged particles 302 are driven by an external electric field of a high voltage level, so the charged particles 302 move upward such that a corresponding pixel displays a white gray level. In the micro-cup 304c, the external electric field is applied to drive the charged particles 302 of the corresponding pixel for displaying a gray level 10. However, the charged particles 302 may move to a position that does not correspond to the applied external electrical field due to the effect of residual voltage when the electrophoretic display device 100 has operated for a period of time, consequently causing display of an incorrect gray level 11. Therefore, a driving method is required to solve this drawback of the prior art.

### SUMMARY OF THE INVENTION

The present invention discloses a method for driving an electrophoretic display device. The electrophoretic display device comprises a plurality of scan lines. The method comprises sequentially enabling the plurality of scan lines from top to bottom when scanning one of a kth set of frames; and sequentially enabling the plurality of scan lines from bottom to top when scanning one of a (k+1)th set of frames. Each set of frames comprises at least one frame, and k is a positive integer greater than or equal to 1.

The present invention further discloses a method for driving an electrophoretic display device. The method comprises providing the electrophoretic display device which comprises a plurality of groups of scan lines; each group including a plurality of scan lines, wherein the scan lines of the plurality of groups are interlaced; sequentially enabling the plurality of scan lines of each group from top to bottom when scanning one of a kth set of frames; and sequentially enabling the plurality of scan lines of each group from bottom to top when scanning one of a (k+1)th set of frames. Each set of frames comprises at least one frame, and k is a positive integer greater than or equal to 1.

The present invention further discloses an electrophoretic display device. The electrophoretic display device comprises a plurality of scan lines; and a gate driver electrically connected to the plurality of scan lines for driving the plurality of scan lines. When scanning one of a kth set of frames, the plurality of scan lines are enabled sequentially from top to bottom, and when scanning one of a (k+1)th set of frames, the plurality of scan lines are enabled sequentially from bottom to top. Each set of frames comprises at least one frame, and k is a positive integer greater than or equal to 1.

The present invention further discloses an electrophoretic display device. The electrophoretic display device comprises n groups of scan lines and a gate driver. Each group of scan lines comprises m scan lines. The n groups of scan lines comprise a plurality of interlaced scan lines. The gate driver is electrically connected to (m*n) scan lines for driving (m*n) scan lines. When scanning one of a kth set of frames, m scan lines of each group are sequentially enabled from top to bottom and n groups are sequentially enabled, and when scanning one of a (k+1)th set of frames, m scan lines of each group are sequentially enabled from bottom to top. n and m are positive integers greater than 1. Each set of frames comprises at least one frame, and k is a positive integer greater than or equal to 1.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional electrophoretic display device.

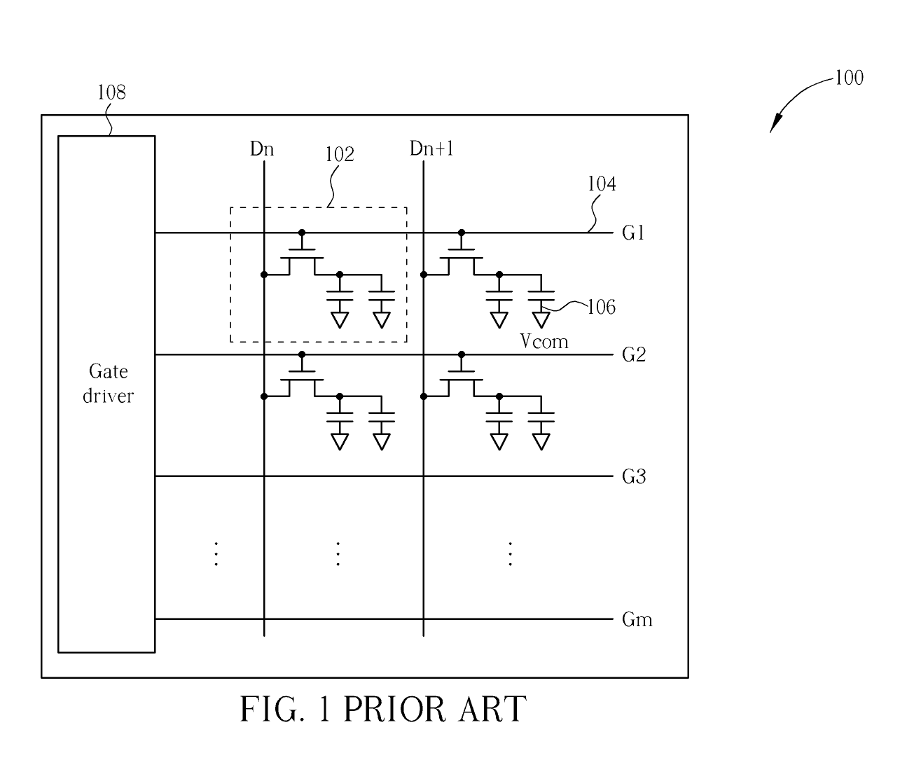

FIG. 2 is a timing diagram illustrating the conventional driving method of the electrophoretic display device shown in FIG. 1.

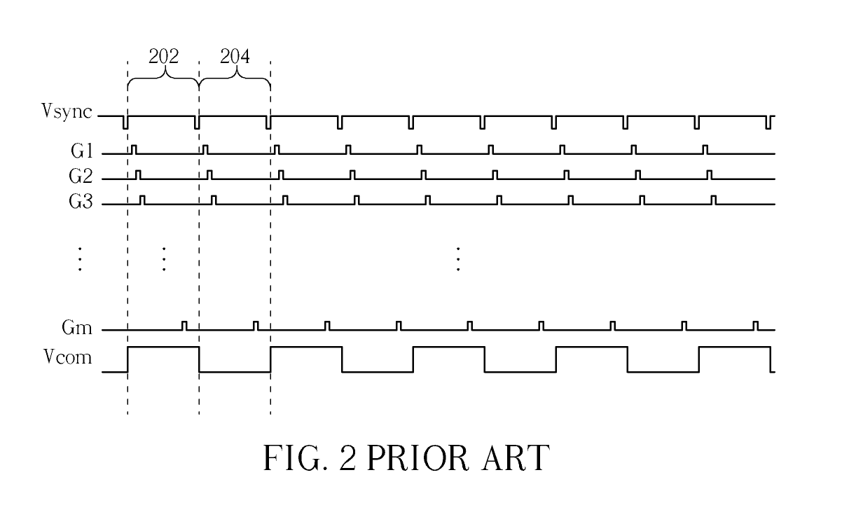

FIG. 3 is a schematic diagram illustrating a micro-cup structure of the electrophoretic display device shown in FIG. 1.

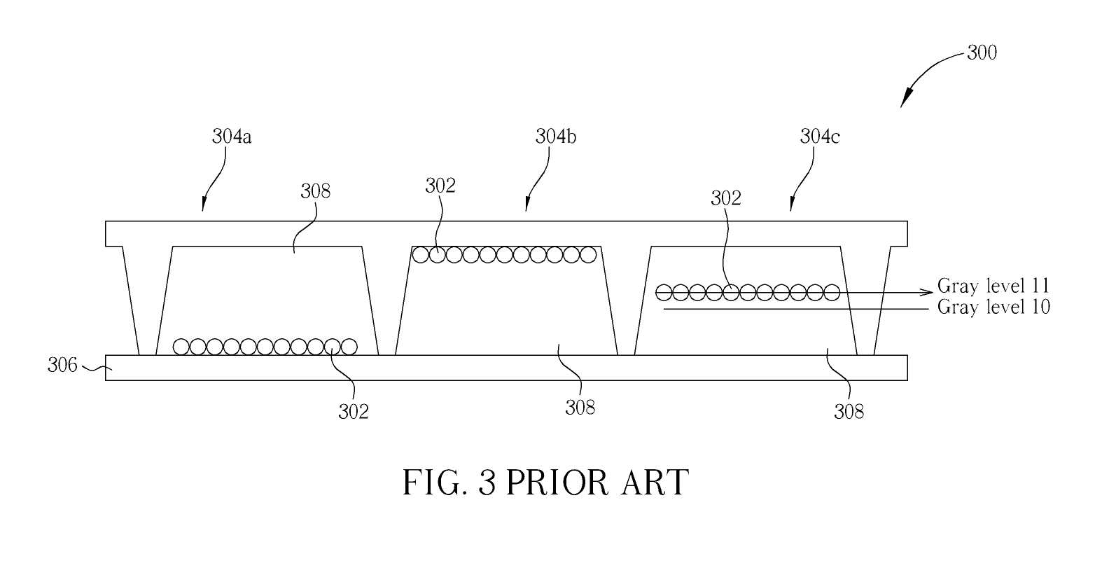

FIG. 4 is a timing diagram illustrating a sequential scan method for driving an electrophoretic display device according to an embodiment of the present invention.

FIG. 5 is a timing diagram illustrating an interlaced scan method for driving an electrophoretic display device according to an embodiment of the invention.

FIG. 6 is a timing diagram illustrating an interlaced scan method for driving an electrophoretic display device according to another embodiment of the present invention.

### DETAILED DESCRIPTION OF THE INVENTION

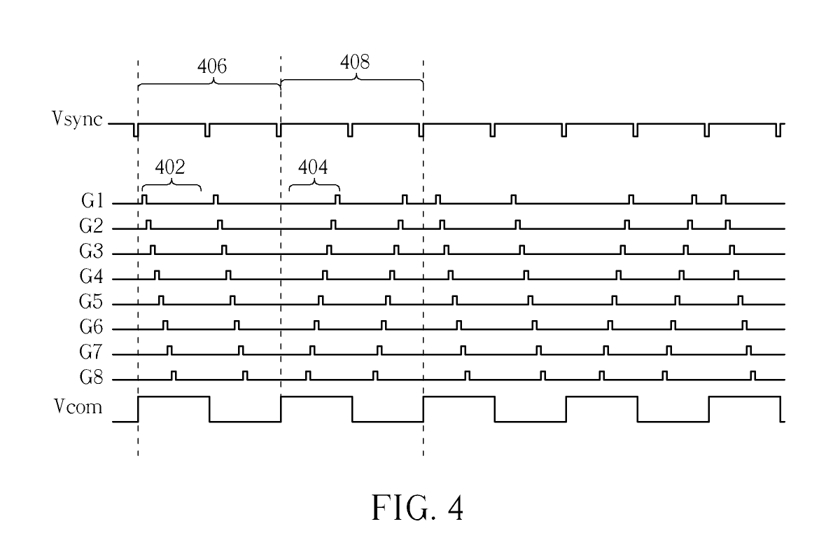

FIG. 4 is a timing diagram illustrating a sequential scan method for driving an electrophoretic display device according to an embodiment of the present invention. In this embodiment, the electrophoretic display device comprises a plurality of scan lines, such as scan lines G1˜G8. When a first set of frames 406 is driven (e.g. enabled) by a vertical synchronous signal Vsync, scan lines G1 to G8 are sequentially driven according to a first driving sequence 402, such that the first scan line G1 is driven first, then the second scan line G2 is driven, then the third scan line G3 is driven, and so on. When a second set of frames 408 is driven by the vertical synchronous signal Vsync, scan lines G1 to G8 are sequentially driven according to a second driving sequence 404 opposite to the first driving sequence 402. For instance, the eighth scan line G8 is driven first, then the seventh scan line G7 is driven, then the sixth scan line G6 is driven, and so on. In other words, the scan lines G1˜G8 are driven from top to bottom according to the first driving sequence 402, and from bottom to top according to the second driving sequence 404 for any two consecutive sets of frames, respectively. Each set of frames comprises at least one frame, for example, as shown in FIG. 4, each set of frames 406 and 408 comprises at least two frames. In addition, the common voltage signal Vcom is converted, for instance, from a high voltage level to a low voltage level, or from a low voltage level to a high voltage level, in any two consecutive frames.

By converting the voltage level of the common voltage signal and reversing the scan line driving sequence, DC voltage accumulation of the charged particles can be avoided, consequently eliminating the issue of incorrect gray level display.

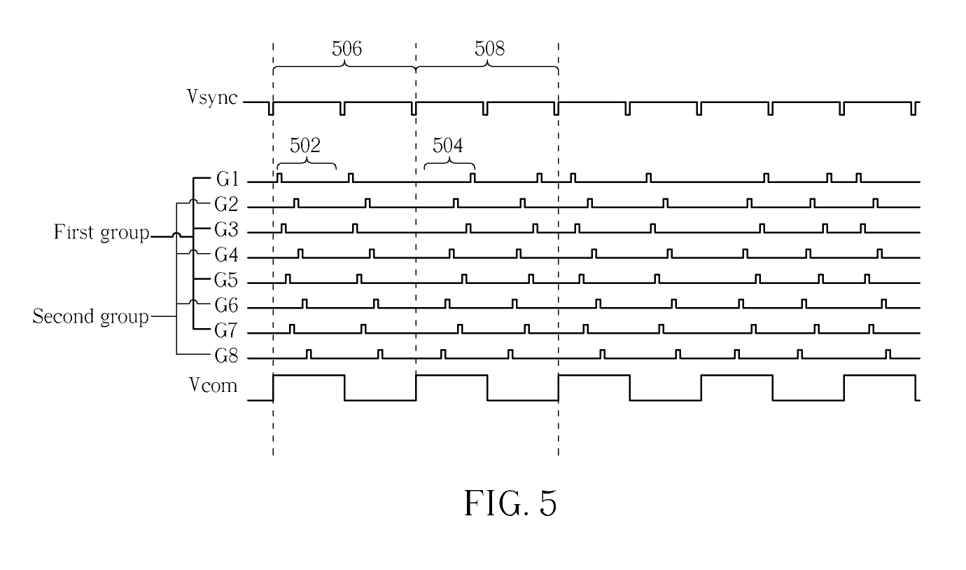

FIG. 5 is a timing diagram illustrating an interlaced scan method for driving an electrophoretic display device according to an embodiment of the invention. In this embodiment, all scan lines G1˜G8 are divided into two groups. The first group includes odd scan lines G1, G3, G5 and G7. The second group includes even scan lines G2, G4, G6 and G8. When the first set of frames 506 is driven by the vertical synchronous signal Vsync, the scan lines are driven according to a first driving sequence 502 such that the first and second groups of scan lines are driven in sequence. For instance, scan lines G1, G3, G5, G7, G2, G4, G6 and G8 are driven sequentially according to the first driving sequence 502. When the second set of frames 508 are driven by the vertical synchronous signal Vsync, the scan lines are driven according to a second driving sequence 504, such that the second group of scan lines is driven in an inverse order, and then the first group of scan lines is driven in an inverse order. For instance, scan lines G8, G6, G4, G2, G7, G5, G3, and G1 are driven sequentially according to the second driving sequence 504. Each set of frames comprises at least one frame. For example, each set of frames comprises at least two frames in FIG. 5. In addition, voltage level of the common voltage signal Vcom is converted in any two consecutive frames.

Since odd and even scan lines are driven in an interlaced manner, and the voltage level of common voltage signal Vcom is converted in any two consecutive frames, the DC balance issue for the electrophoretic display device can be improved effectively.

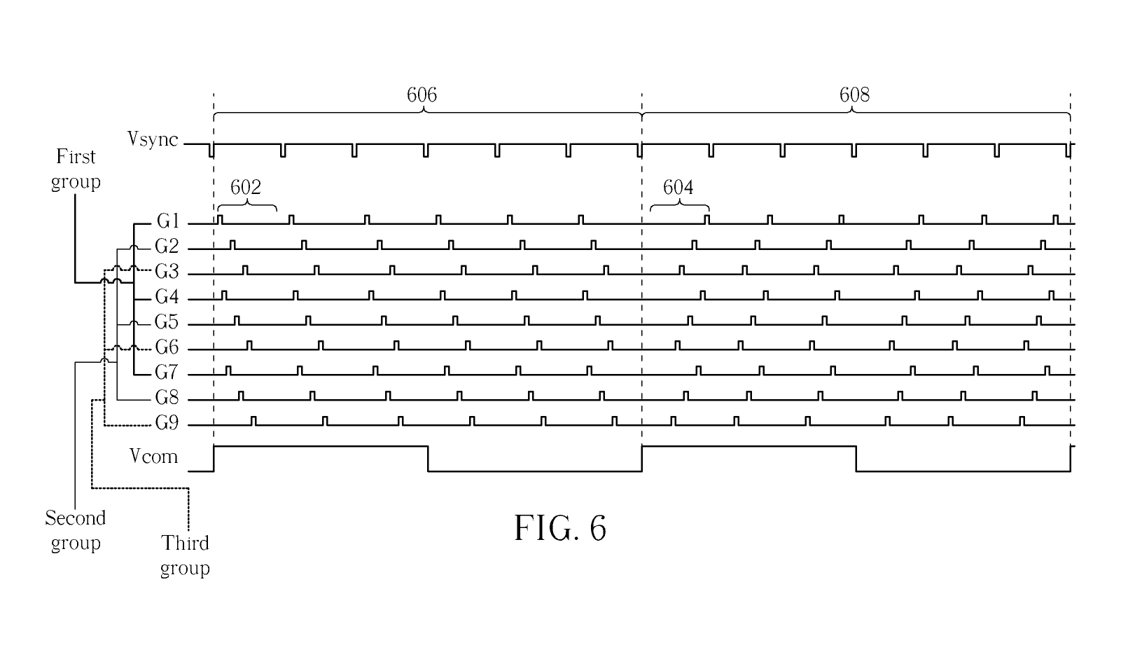

FIG. 6 is a timing diagram illustrating an interlaced scan method for driving an electrophoretic display device according to another embodiment of the present invention. In this embodiment, all scan lines G1˜G8 are divided into three groups. The first group includes scan lines G1, G4 and G7. The second group includes scan lines G2, G5 and G8. The third group includes scan lines G3, G6 and G9. When the first set of frames 606 is driven by the vertical synchronous signal Vsync, the scan lines are sequentially driven according to a first driving sequence 602, such that the first, second and third groups of scan lines are driven sequentially. For instance, scan lines G1, G4, G7, G2, G5, G8, G3, G6 and G9 are driven sequentially according to the first driving sequence 602. When the second set of frames 608 is driven by the vertical synchronous signal Vsync, the scan lines are sequentially driven according to a second driving sequence 604, such that the third group of scan lines is driven in an inverse order, then the second group of scan lines is driven in an inverse order, and then the first group of scan lines is driven in an inverse order. For instance, scan lines G9, G6, G3, G8, G5, G2, G7, G4, and G1 are driven sequentially according to the second driving sequence 604. Each set of frames comprises at least one frame. For example, each set of frames comprises at least six frames in FIG. 6. As shown in FIG. 6, the voltage level of common voltage signal Vcom is converted every three frames, and each driving sequence corresponds to one cycle of the common voltage signal Vcom.

By dividing the scan lines into three interlacing groups and converting the common voltage signal Vcom every three frames, the DC voltage balance issue for the electrophoretic display device can be improved effectively.

Please note that the above embodiments of the driving method for the electrophoretic display device are merely exemplary illustrations of the present invention, and those skilled in the art can certainly make appropriate modifications according to practical demands, such as utilizing a different number of scan lines, which also belongs to the scope of the present invention.

In conclusion, the electrophoretic display device and the method of driving the electrophoretic display device drive all scan lines in different sequences and convert voltage level of the common voltage signal accordingly, so as to balance DC voltage of the electrophoretic display device and eliminate the incorrect gray level display issue.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

Those skilled in the art will readily observe that numerous modifications and alterations of the device and method may be made while retaining the teachings of the invention.

What is claimed is:

1. A method for driving an electrophoretic display device, the electrophoretic display device comprising a plurality of scan lines, the method comprising:
sequentially enabling the plurality of scan lines from top to bottom when scanning one of a kth set of frames; and
sequentially enabling the plurality of scan lines from bottom to top when scanning one of a (k+1)th set of frames;
wherein each set of frames comprises at least one frame, and k is a positive integer greater than or equal to 1.

2. The method of claim 1, wherein the electrophoretic display device further comprises a common line for providing a common voltage signal, and the method further comprises providing different common voltage signals with different voltage levels to any two consecutive frames.

3. The method of claim 1, wherein the electrophoretic display device further comprises a common line for providing a common voltage signal, and the method further comprises providing different common voltage signals with opposite voltage levels to any two consecutive frames.

4. The method of claim 1, wherein the electrophoretic display device further comprises a common line for providing a common voltage signal, and the method further comprises providing different common voltage signals with different voltage levels to any two consecutive half sets of frames.

5. The method of claim 1, wherein each set of frames comprises at least two frames.

6. A method for driving an electrophoretic display device, the method comprising:
providing the electrophoretic display device which comprises a plurality of groups of scan lines, each group including a plurality of scan lines, wherein the scan lines of the plurality of groups are interlaced;
sequentially enabling the plurality of scan lines of each group from top to bottom when scanning one of a kth set of frames; and
sequentially enabling the plurality of scan lines of each group from bottom to top when scanning one of a (k+1)th set of frames;
wherein each set of frames comprises at least one frame, and k is a positive integer greater than or equal to 1.

7. The method of claim 6, wherein the electrophoretic display device further comprises a common line for providing a common voltage signal, and the method further comprises providing different common voltage signals with different voltage levels to any two consecutive frames.

8. The method of claim 6, wherein the electrophoretic display device further comprises a common line for providing a common voltage signal, and the method further comprises providing different common voltage signals with opposite voltage levels to any two consecutive frames.

9. The method of claim 6, wherein the electrophoretic display device further comprises a common line for providing a common voltage signal, and the method further comprises providing different common voltage signals with different voltage levels to any two consecutive half set of frames.

10. The method of claim 6, wherein each set of frames comprises at least two frames.

11. The method of claim 6, wherein the plurality of groups of scan lines comprises a first group of scan lines and a second group of scan lines, the first group of scan lines comprises odd scan lines, and the second group of scan lines comprises even scan lines.

12. The method of claim 6, wherein the plurality of groups of scan lines comprises a first, a second and a third groups of scan lines, the first group of scan lines comprises (3N−2)th scan lines, the second group of scan lines comprises (3N−1)th scan line, the third group of scan lines comprises (3N)th scan line, and N is a positive integer greater than or equal to 1.

13. The method of claim 12, wherein each set of frames comprises at least 3 frames or a multiple of 3 frames.

14. An electrophoretic display device comprising:
a plurality of scan lines; and
a gate driver electrically connected to the plurality of scan lines for driving the plurality of scan lines;
wherein when scanning one of a kth set of frames, the plurality of scan lines are enabled sequentially from top to bottom, and when scanning one of a (k+1)th set of frames, the plurality of scan lines are enabled sequentially from bottom to top;
wherein each set of frames comprises at least one frame, and k is a positive integer greater than or equal to 1.

15. The electrophoretic display device of claim 14, further comprising at lest one common line for providing a common voltage signal to the electrophoretic display device.

16. The electrophoretic display device of claim 15, wherein the common line provides different common voltage signals with opposite voltage levels to any two consecutive frames.

17. The electrophoretic display device of claim 15, wherein the common line provides different common voltage signals with different e voltage levels to any two consecutive frames.

18. The electrophoretic display device of claim 15, wherein the common line provides different common voltage signals with different voltage levels to any two consecutive half sets of frames.

19. The electrophoretic display device of claim 14, wherein each set of frames comprises at least two frames.

20. An electrophoretic display device comprising:
n groups of scan lines, each group of scan lines comprising m scan lines, wherein the n groups of scan lines comprise a plurality of interlaced scan lines; and
a gate driver electrically connected to (m*n) scan lines for driving (m*n) scan lines;
wherein when scanning one of a kth set of frames, m scan lines of each group are sequentially enabled from top to bottom and n groups are sequentially enabled, and when scanning one of a (k+1)th set of frames, m scan lines of each group are sequentially enabled from bottom to top;
wherein n and m are positive integers greater than 1;
wherein each set of frames comprises at least one frame, and k is a positive integer greater than or equal to 1.

21. The electrophoretic display device of claim 20, further comprising at least one common line for providing a common voltage signal.

22. The electrophoretic display device of claim 21, wherein the common line provides different common voltage signals with opposite voltage levels to any two consecutive frames.

23. The electrophoretic display device of claim 21, wherein the common line provides different common voltage signals with different e voltage levels to any two consecutive frames.

24. The electrophoretic display device of claim 21, wherein the common line provides different common voltage signals with different e voltage levels to any two consecutive half sets of frames.

25. The electrophoretic display device of claim 20, wherein each set of frames comprises at least two frames.

26. The electrophoretic display device of claim 20, wherein the n groups of the scan lines comprise a first group and a second group of scan lines, the first group of scan line includes odd scan lines, and the second group of scan line includes even scan lines.

27. The electrophoretic display device of claim 20, wherein the n groups of scan lines comprise a first, a second and a third groups of scan lines, the first group of scan lines comprises (3N−2)th scan lines, the second group of scan lines comprises (3N−1)th scan lines, the third group of scan line comprises (3N)th scan lines, and N is a positive integer greater than or equal to 1.

28. The electrophoretic display device of claim 27, wherein each set of frames comprises at least 3 frames, or a multiple of 3 frames.
